(19) United States
(12) Patent Application Publication
(10) Pub. No.: US 2023/0409265 A1
(43) Pub. Date: Dec. 21, 2023

(54) PROGRAM, MOBILE TERMINAL CONTROL METHOD, MOBILE TERMINAL, AND INFORMATION PROCESSING DEVICE

(71) Applicant: SmartNews, Inc., Tokyo (JP)

(72) Inventors: Kosuke INOUE, Tokyo (JP); Akiko Kunugi, Tokyo (JP)

(73) Assignee: SmartNews, Inc., Tokyo (JP)

(21) Appl. No.: 18/316,782

(22) Filed: May 12, 2023

(30) Foreign Application Priority Data
May 19, 2022 (JP) 2022-082444

(51) Int. Cl. G06F 3/14; H04N 5/265; G09B 29/00

(52) U.S. Cl. CPC G06F 3/14; G09B 29/003; H04N 5/265

(57) ABSTRACT

A user can easily select a live camera image of a desired position on a map. A mobile terminal 30 displays a map on which, from among object images of a plurality of types, an object image of a type having an attribute of an image target of an image capture device disposed at a predetermined position is overlaid at a position corresponding to the predetermined position, receives selection of the displayed object image, and displays both the map and an image captured by the image capture device corresponding to the selected object image on one screen.

### TECHNICAL FIELD

The present disclosure relates to technology for displaying both an image and a map on one screen.

### BACKGROUND

Known are techniques for displaying both an image and a map on one screen.

For example, JP 2014-206402A discloses a technology by which an image of a location to be passed by a vehicle is superimposed on a map on a screen of a navigation device in the vehicle.

### SUMMARY

The technology disclosed in JP 2014-206402A does not enable a user to easily search for a desired live camera image.

The present invention provides a technology that enables a user to easily select for display on a map a live camera image of a desired location.

In an embodiment of the present invention there is disclosed a program for causing a computer to execute the steps of; displaying a map on which, from among object images of a plurality of types, an object image of a type having an attribute of a target of an image capture device disposed at a predetermined position is overlaid at a position corresponding to the predetermined position; and receiving selection of the object image displayed in the displaying step, wherein in the displaying step, both the map and an image captured by the image capture device corresponding to the selected object image are displayed on one screen.

In another embodiment, the present disclosure provides a terminal control method that includes the steps of; displaying a map on which, from among object images of a plurality of types, an object image of a type having an attribute of a target of an image capture device disposed at a predetermined position is overlaid at a position corresponding to the predetermined position; and receiving selection of the object image displayed in the displaying step, wherein in the displaying step, both the map and an image captured by the image capture device corresponding to the selected object image are displayed on one screen.

In yet another embodiment, the present disclosure provides a terminal that includes: a display means for displaying a map on which, from among object images of a plurality of types, an object image of a type having an attribute of an image target of an image capture device disposed at a predetermined position is overlaid at a position corresponding to the predetermined position; and a receiving means for receiving the object image displayed by the display means, wherein the display means displays both the map and an image captured by the image capture device corresponding to the selected object image on one screen.

In still another embodiment, the present disclosure provides an information processing device communicable with a terminal that includes a display unit, the information processing device including: a storage means for storing a correspondence relationship between an image capture device, position information of the image capture device, and attribute information of an imaging target of the image capture device, and a correspondence relationship between the attribute information and an object image; a display control means for controlling the display unit to display a map and, from among object images of a plurality of types, an object image of a type having the attribute information at a position corresponding to the position information; and a receiving means for receiving selection of the object image displayed under control of the display control means, wherein the display control means controls the display unit to display, on one screen, both the map and an image captured by an image capture device corresponding to the object image corresponding to the selection received by the receiving means.

### Effects

According to the present invention, a user can easily select on a map a live camera image of a desired location.

### BRIEF DESCRIPTION OF THE DRAWINGS

FIG. 1 is a diagram illustrating a configuration of an information processing system according to an embodiment.

FIG. 2 is a diagram illustrating a functional configuration of the information processing system.

FIG. 3 is a diagram illustrating a hardware configuration of a server.

FIG. 4 is a diagram illustrating a hardware configuration of a mobile terminal.

FIG. 5 is a sequence diagram illustrating processing for displaying a current live camera image and a map image.

FIG. 6 is a diagram illustrating a network camera database.

FIG. 7 is a diagram illustrating an object image database.

FIG. 8 is a diagram showing display of object images on a mobile terminal.

FIG. 9 is a sequence diagram illustrating processing for displaying a past live camera image and a map image on one screen.

FIG. 10 is a diagram showing display of a time slider image on a mobile terminal.

FIG. 11 is a diagram showing simultaneous display of a current live camera image and a past live camera image on a mobile terminal.

FIG. 12 is a diagram showing simultaneous display of an image related to rain clouds and a live camera image on a mobile terminal.

### DETAILED DESCRIPTION

1. Configuration

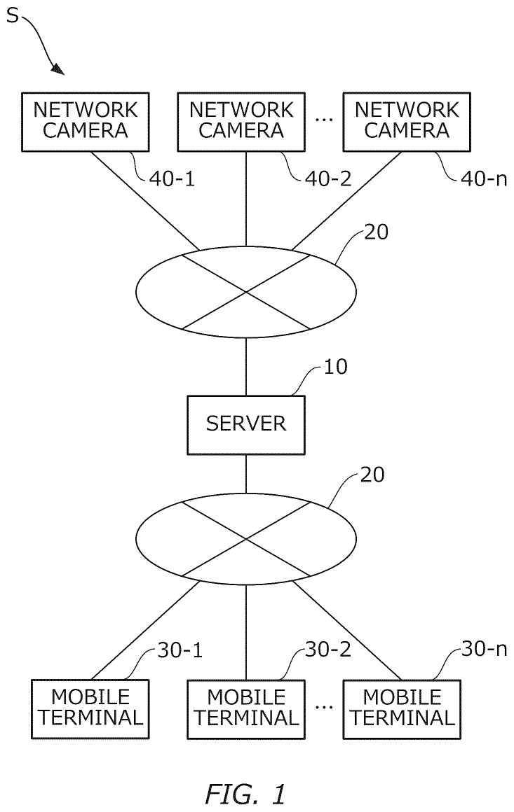

FIG. 1 is an illustrative overview of information processing system S according to an embodiment. Information processing system S includes server 10, network 20, mobile terminals 30-1, 30-2, . . . , 30-n (hereinafter, collectively referred to as mobile terminal 30), and network cameras (image capture devices) 40-1, 40-2, . . . , and 40-n (hereinafter, collectively referred to as network camera 40). Server 10 is connected to network 20. Mobile terminal 30 and network camera 40 connect to network 20.

Network 20 is a network such as the Internet. When mobile terminal and network camera 40 connect to network 20 they are communicable with server 10.

Network camera 40 is installed at a predetermined position and captures still and/or moving images (hereinafter, collectively referred to simply as images). A frame rate of network camera 40 is set in advance by an administrator or the like of network camera 40. Network camera 40 has a storage means (not shown) for storing image data. Network camera 40 transmits captured images (captured images or live camera images) to server 10.

Mobile terminal 30 is a mobile information terminal capable of wireless communication, such as a smart phone, and carriable by a user. Mobile terminal 30 communicates with server 10 and displays information transmitted from server 10. Mobile terminal 30 displays on its screen an object image superimposed on a map image. A position of the object image superimposed on the map image corresponds to a position in real space of network camera 40. Mobile terminal 30 displays an image captured by network camera 40 that corresponds to the object image selected by the user of mobile terminal 30.

Server 10 is a server that transmits to mobile terminal 30 map information for an area specified by the user of mobile terminal 30. Furthermore, server 10 is a server that transmits images captured by network camera 40 to mobile terminal 30.

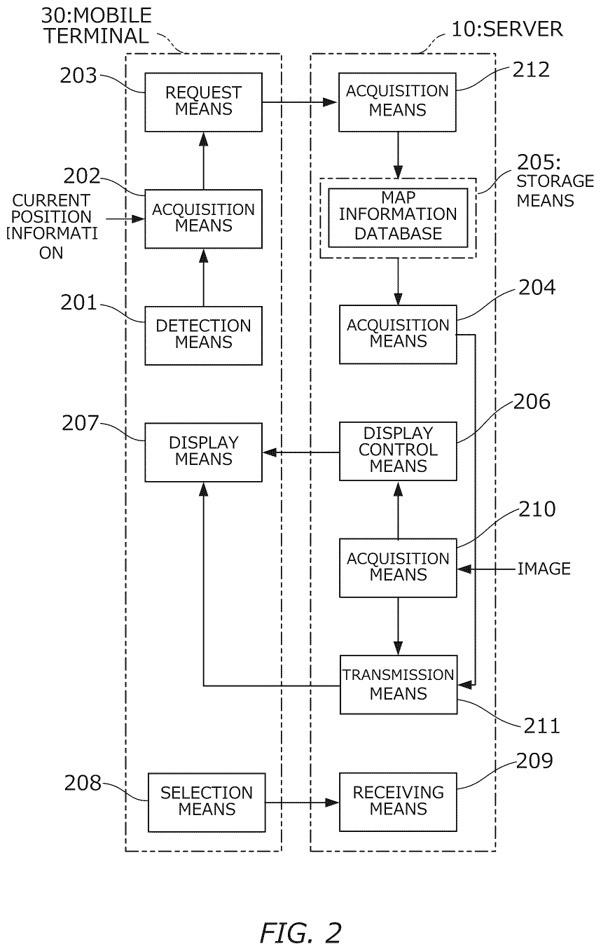

FIG. 2 is a diagram illustrating a functional configuration of information processing system S. Information processing system S includes detection means 201, acquisition means 202, request means 203, acquisition means 204, storage means 205, display control means 206, display means 207, selection means 208, receiving means 209, acquisition means 210, and transmission means 211. Acquisition means 204, storage means 205, display control means 206, receiving means 209, acquisition means 210, and transmission means 211 are implemented at server 10. Detection means 201, acquisition means 202, request means 203, display means 207, and selection means 208 are implemented at mobile terminal 30.

Following is a description of functions of server 10. Storage means 205 stores various types of data, including a network camera database, an object image database, map information, and object image data.

Acquisition means 204 acquires map information, image capture device position information, and object image information from the network camera database and the object image database stored in storage means 205. The map information is information generated based on current position information of mobile terminal 30, and is transmitted from mobile terminal 30. The map information is information for a region that includes a current position of mobile terminal 30, and is transmitted to server 10 by request means 203 of mobile terminal 30. The image capture device position information is current position information of network camera 40. The object image information is information related to an object image. Object images are stored in storage means 205 in association with categories (attributes or attribute information) of image targets of network camera 40. The object image information includes, for example, a category of the imaging target of network camera 40 and a file name of an object image.

Display control means 206 performs display control such that display 3051 of mobile terminal 30 displays a map image, an object image, and a time slider image. The time slider image is an image for display on the mobile terminal 30 to select a capture time of a captured image. The object image is superimposed on the map image. The time slider image and the map image are displayed on one screen. Here, “displayed on one screen” means that all images to be displayed are displayed on one display 3051. Display control means 206 performs display control such that an image captured by network camera 40 is displayed on display 3051 of mobile terminal 30. The image captured by network camera 40 and the map image are displayed on one screen. Here, display the captured image and the map image on one screen means that the captured image and the map image are displayed on the same screen. Here, “display on one screen” includes displaying a plurality of superimposed images. The captured image and the map image may be displayed such that a part or all of one image is superimposed on the other image.

Receiving means 209 receives an object image selected by the user by an operation performed on mobile terminal 30. Acquisition means 210 acquires from network camera 40 an image captured by network camera 40. Transmission means 211 transmits, to mobile terminal 30, an object image, a time slider image, and a map image based on the current position information of mobile terminal 30. Also, transmission means 211 transmits, to mobile terminal 30, an image captured by network camera 40. Transmission means 211 also transmits options for dates and times of images captured by network camera 40.

Following is a description of functions of mobile terminal 30. Detection means 201 detects startup of an application program (hereinafter, referred to as an “app”) managed by server 10.

Acquisition means 202 acquires current position information of mobile terminal 30 from positioning system 307. Namely, acquires information indicating the current position of mobile terminal 30 on the earth. Request means 203 requests server 10 to transmit a map image for display on the display of mobile terminal 30. Request means 203 also transmits the current position information acquired by mobile terminal 30 to server 10 via communication unit 304.

Display means 207 displays the map image, the object image, and the time slider image received from server 10 on display 3051 of mobile terminal 30. Display means 207 superimposes an object image on the map image. Furthermore, display means 207 displays the time slider image and the map image on one screen. Also, display means 207 displays both the map image and an image captured by network camera 40 on one screen.

Selection means 208 selects an object image via the communication unit 304 in accordance with an operation performed on mobile terminal 30 by the user. Specifically, the user touches an object image displayed on display 3051 of mobile terminal 30. Also, selection means 208 selects a capture time via communication unit 304 in accordance with an operation performed on mobile terminal 30 by the user. Specifically, the user touches a point on the time slider image displayed on the display of mobile terminal 30.

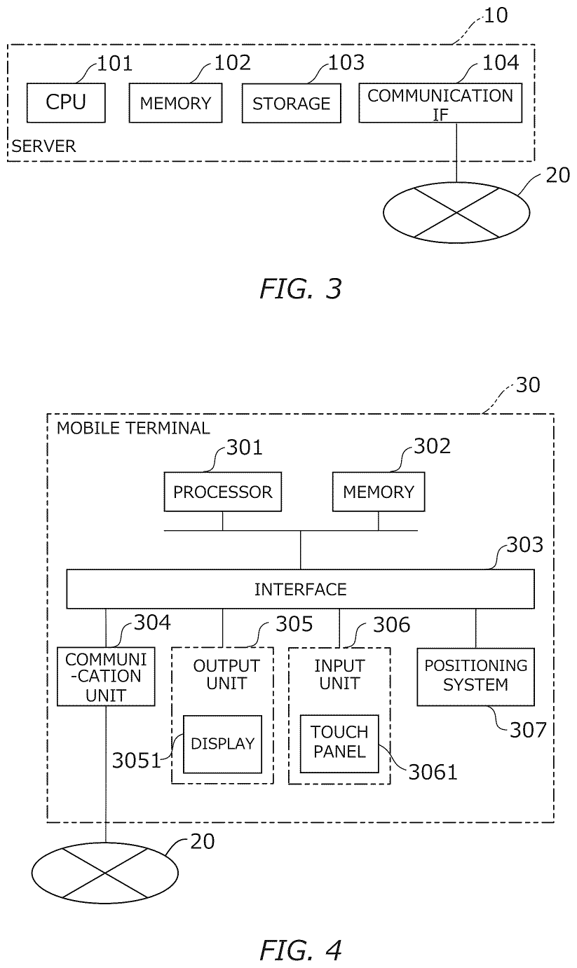

FIG. 3 is a diagram illustrating the hardware configuration of server 10. Server 10 is a computer device that includes CPU (Central Processing Unit) 101, memory 102, storage 103, and communication IF (Interface) 104. CPU 101 is a processor that executes programs for performing various types of calculation and controlling other hardware units of server 10. Memory 102 is a main storage device that functions as a work area when CPU 101 executes programs. Storage 103 is a non-volatile auxiliary storage device that stores various programs and data. Communication IF 104 is a communication device that performs communication with other devices using a predetermined communication standard (e.g., Ethernet (registered trademark)).

In this example, storage 103 stores a program for causing a computer device to function as server 10 in information processing system S (hereinafter referred to as “server program”). The functions shown in FIG. 3 are implemented in the computer device by CPU 101 executing the server program. While CPU 101 is executing the server program, either memory 102 or storage 103 functions as an example of storage means 205, CPU 101 functions as an example of display control means 206, receiving means 209, and transmission means 211, and communication IF 104 functions as an example of acquisition means 204 and acquisition means 210.

FIG. 4 is a diagram illustrating the hardware configuration of mobile terminal 30. Mobile terminal 30 is a computer device that includes processor 301, memory 302, interface 303, communication unit 304, output unit 305, input unit 306, and positioning system 307. These constituent units are connected by a bus or the like and can communicate with each other.

Processor 301 controls the units of mobile terminal 30 by reading and executing a computer program (hereinafter simply referred to as a “program”) stored in memory 302. Processor 301 is a CPU (Central Processing Unit), for example. Memory 302 is a storage means for storing an operating system, various programs, data, and the like that are read by processor 301. Memory 302 includes a RAM (Random Access Memory) and a ROM (Read Only Memory). Note that memory 302 may include a solid state drive, a hard disk drive, or the like. Interface 303 is a communication circuit that connects processor 301 with communication unit 304, output unit 305, input unit 306, and positioning system 307 to enable communication therewith. Communication unit 304 controls communication performed with server 10 via network 20. Output unit 305 includes a display unit (e.g., a display) and an audio output unit (e.g., a speaker), and outputs images, text, and/or audio. Specifically, output unit 305 is constituted of display 3051 in the present embodiment. Display 3051 is constituted of a flat panel display such as a liquid crystal display or an organic EL display, and outputs images and text. Input unit 306 is an operation unit constituted of a keyboard, a mouse, or the like, and enables input of various kinds of information in accordance with user operations. In the present embodiment, input unit 306 is constituted of touch panel 3061. Touch panel 3061 is an electronic input device that is integrated with display 3051 (flat panel display), and enables the user to perform touch operations via display 3051. Positioning system 307 is a satellite positioning system such as GPS (Global Positioning System), for example, and is a system for obtaining a current position on the earth.

In this example, the functions shown in FIG. 2 are implemented in mobile terminal 30 by processor 301 executing a program. While processor 301 is executing the program, processor 301 functions as an example of detection means 201, acquisition means 202, and selection means 208, communication unit 304 functions as an example of request means 203, and display 3051 functions as an example of display means 207.

A smart phone is used as mobile terminal 30 in the present embodiment, but a PC (personal computer), a tablet PC, or the like may be used. A desktop computer may also be used.

2. Operations

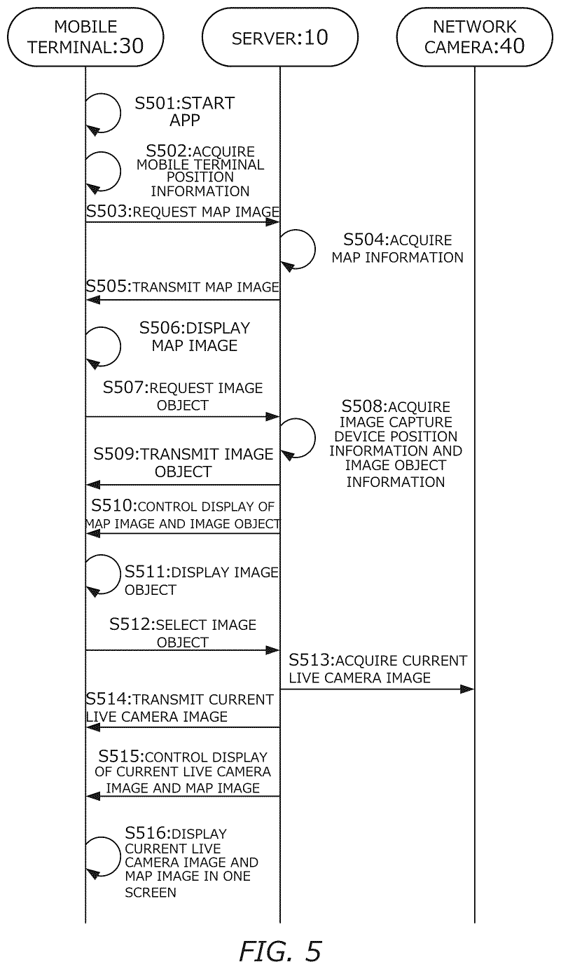

FIG. 5 is a sequence diagram illustrating processing for displaying a current live camera image and a map image. A current live camera image is a live camera image currently being captured by network camera 40. A live camera image is a current image captured by network camera 40 or an image captured in the past by network camera 40. Information processing system S is a system for displaying a map image and a live camera image on one screen of display 3051 of mobile terminal 30, and executes the processing shown in FIG. 5. Specifically, in information processing system S, the processor of mobile terminal 30 executes processing for displaying a map image on which, from among object images of various types, an object image of a type that corresponds to a category of an image target of network camera 40 disposed at a predetermined position is overlaid at a position corresponding to the predetermined position, receiving selection of the displayed object image, and displaying both the map image and an image captured by network camera 40 corresponding to the selected object image on one screen. Also, server 10 of information processing system S stores a correspondence relationship between network camera 40, position information of network camera 40, and categories of imaging targets of network camera 40, stores a correspondence relationship between the categories and object images, and executes processing for performing control to cause the display of mobile terminal 30 to display a map image and, from among object images of a plurality of types, object images of types corresponding to the categories at positions corresponding to the position information, receiving selection of a displayed object image, and performing control to display both the map image and an image captured by network camera 40 corresponding to the selected object image on one screen.

At step S501, detection means 201 of mobile terminal 30 detects startup of the app.

At step S502, acquisition means 202 (corresponding to position information acquisition means) of mobile terminal 30 acquires the current position information of mobile terminal 30 from positioning system 307.

At step S503, request means 203 of mobile terminal 30 requests server 10 to transmit data for displaying a map image on display 3051 of mobile terminal 30. The request includes the current position information of mobile terminal 30 acquired at step S502.

At step S504, acquisition means 204 of server 10 acquires map information. The map information is map information stored in storage means 205 and includes a map image. If map information that corresponds to the current position information is not stored in storage means 205, the map information is acquired from an external server that has the map information, and the map information is stored in memory 302.

At step S505, transmission means 211 of server 10 transmits, to mobile terminal 30, data for displaying a map image that corresponds to the current position information of mobile terminal 30.

At step S506, display means 207 of mobile terminal 30 displays the map image. The map image is displayed on mobile terminal 30 in a manner such that the position on the map image that corresponds to the current position of mobile terminal 30 is substantially in the center of display 3051 of mobile terminal 30.

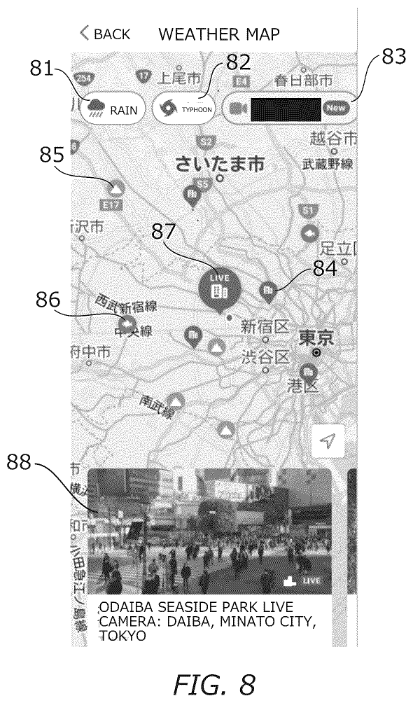

At step S507, request means 203 of mobile terminal 30 requests server 10 to transmit data for displaying an object image on display 3051 of mobile terminal 30. Specifically, live camera button 83, which is displayed together with the map image shown in FIG. 8, is selected. The object image indicates a location and type of the corresponding network camera 40. Live camera button 83 is selected by being touched on the map screen by the user.

FIG. 8 is a diagram showing display of object images on mobile terminal 30. In the diagram shown in FIG. 8, rain cloud button 81, typhoon button 82, and live camera button 83 are displayed. Rain cloud button 81, typhoon button 82, and live camera button 83 are object images for selecting a type of information to be displayed as superimposed on the map image (hereinafter referred to as display selection object images). When rain cloud button 81 is selected, mobile terminal 30 overlays an image related to rain clouds on the map image, and when typhoon button 82 is selected, mobile terminal 30 overlays an image related to a typhoon on the map image. The image related to rain clouds is a rain cloud radar image, for example. The image related to a typhoon is a typhoon path map, a typhoon track forecast map, or an image showing a shape of a typhoon, for example. When live camera button 83 is selected, mobile terminal 30 overlays an object image related to a live camera (corresponding to the network camera) on the map image. When rain cloud button 81, typhoon button 82, or live camera button 83 is selected, the selected button is displayed differently from the other two buttons. For example, in FIG. 8, the background color of rain cloud button 81 and the background color of typhoon button are the same, but the background color of live camera button 83 is different from the background color of rain cloud button 81 and the background color of typhoon button.

When live camera button 83 is selected by the user, an object image is displayed as superimposed on the map image on mobile terminal 30 as shown in FIG. 8. In addition to buttons 81, 82 and 83, four types of object images are displayed in FIG. 8. Object image 84, which includes an illustration of a building, is an object image indicating that the category of the imaging target of network camera 40 is a building. Object image 85, which includes an illustration of a mountain, is an object image indicating that the category of the imaging target of network camera 40 is a mountain. Object image 86, which includes an illustration of a fish, is an object image indicating that the category of the imaging target of network camera 40 is a river. Object image 87, which includes an illustration of a building, is an object image indicating that the category of the imaging target of network camera 40 is a building, but the appearance is different from the other object images. Here, “the appearance is different” means, for example, a different size from other object images, and/or an enhanced appearance. ( ) In the diagram shown in FIG. 8, object image 87 has been selected by the user. Object image 87 includes the text “LIVE” and is larger in size than the other object images. In this example, an object image is indicated as selected by inclusion of the text “LIVE” and by having a size larger than the other object images. Live camera image 88 indicates a live camera image currently being captured by network camera 40 that corresponds to the selected object image. In this example, live camera image 88 is the current live camera image captured by network camera 40 that corresponds to object image 87.

At step S508, acquisition means 204 (corresponding to object image acquisition means) of server 10 acquires image capture device position information and object image information. The image capture device position information is obtained from a network camera database. Specifically, acquisition means 204 of server 10 specifies a display range for the map image on mobile terminal 30 by use of the current position information of mobile terminal 30, which was acquired at step S504, and a scale of the map image for display on mobile terminal 30. Also, acquisition means 204 of server 10 acquires from the network camera database information related to network camera 40 located within the specified display range. The acquired information related to network camera 40 includes information indicating categories of network camera 40. The object image information is acquired from an object image database. Server 10 acquires from storage means 205 data for object images that correspond to the categories of network camera 40, in accordance with the acquired object image information.

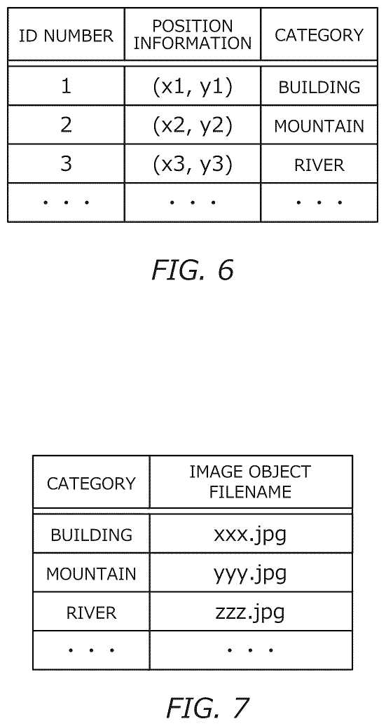

FIG. 6 is a diagram illustrating an example of the network camera database. Image capture device position information is stored in the network camera database. Each piece of image capture device position information includes an identification number, position information, and a category, for example. The identification number is a number for uniquely identifying the corresponding network camera 40, and is assigned to each network camera 40. The position information indicates the location of the corresponding network camera 40, and is represented by coordinates using latitude and longitude, for example. The category is the category of the imaging target of the corresponding network camera 40, and can be freely set by the administrator of information processing system S. Examples of categories include but are not limited to “building,” “mountain,” “river,” “architectural structure,” “nature,” “person,” “public facility,” “park,” “station,” “road,” “intersection,” and “parking lot.”

FIG. 7 is a diagram illustrating an example of the object image database. Object image information is stored in the object image database. Each piece of object image information includes a category and an object image file name, for example. The category is the category of the imaging target of the corresponding network camera 40, and examples include at least the categories included in the network camera database shown in FIG. 6. The object image file name is the file name of the object image that corresponds to the category. The object image file name is different for each category. Namely, for each category of imaging target of network camera 40, a different object image is displayed as superimposed on the map image.

at step S509, transmission means 211 of server 10 transmits, to mobile terminal 30, an object image that corresponds to the map image displayed on mobile terminal 30. The object image that server 10 transmits to mobile terminal 30 is an object image that corresponds to network camera located in an area that corresponds to the map image acquired by server at step S504 (corresponding to the image capture device disposed at a predetermined position). For example, if network camera 40, whose imaging target is of the category “building” is disposed in the area that corresponds to the map image that corresponds to the current position information of mobile terminal 30, server 10 transmits object image data with the image object file name “xxx.jpg” to mobile terminal 30.

At step S510, display control means 206 of server 10 controls display of mobile terminal 30 such that the object image is displayed as superimposed on the map image. Specifically, display control means of server 10 transmits the position information of the object image in the map image. The position of the object image in the map image corresponds to the position in real space of network camera 40 that is located in the area that corresponds to the map image (corresponding to the predetermined position). Namely, transmitting the position information of the object image in the map image corresponds to transmitting the position information of network camera 40.

At step S511, display means 207 of mobile terminal 30 superimposes the object image transmitted from server 10 at step S509 on the map image displayed at step S506, in accordance with the display control at step S510. When an instruction to change the display range of the map image on mobile terminal 30 is received from the user, an object image that corresponds to the map image in the new display range is superimposed on the map image with the new display range. The instruction to change the display range of the map image is, for example, an operation such as a touch, a drag, a pinch-out, or a pinch-in performed on display 3051 by the user.

At step S512, selection means 208 of mobile terminal 30 selects an object image displayed on display 3051 in accordance with an operation performed on mobile terminal 30 by the user. Specifically, selection means 208 of mobile terminal 30 transmits coordinates of the touched position on the map image (coordinates on the screen) to server 10. Receiving means 209 of server 10 receives the selection of the object image. Specifically, receiving means 209 of server 10 receives the coordinates of the touched position on the map image displayed on mobile terminal 30 (coordinates on the screen) from mobile terminal 30.

At step S513, acquisition means 210 of server 10 identifies network camera 40 that corresponds to the object image selected at step S508. Using the network camera database and the coordinates received by server 10 at step S512, the corresponding network camera 40 is specified by checking which of network camera 40 located in the area corresponding to the map image is located at a real space position that corresponds to the position of the object image selected at step S512 on the map image. For example, in a case that the coordinates received by server 10 at step S512 are included in the coordinates of the position of the object image on the map image (coordinates on the screen), and the position of network camera 40 in real space indicated by the object image is (xl, yl), then the network camera with the identification number 1 is specified as network camera 40 that corresponds to the object image selected at step S512. Acquisition means 210 of server 10 acquires the current live camera image from the specified network camera 40.

At step S514, transmission means 211 of server 10 transmits the current live camera image acquired at step S513 to mobile terminal 30.

At step S515, display control means 206 of server 10 controls the display on mobile terminal 30 such that the current live camera image and the map image transmitted at step S510 are displayed on one screen.

At step S516, display means 207 of mobile terminal 30 displays both the current live camera image and the map image transmitted at step S510 on one screen as shown in FIG. 8. Namely, the live camera image is displayed on display 3051 of mobile terminal 30 in real time. Also, at step S516, the object image selected at step S512 is displayed in a larger size than the object image displayed at step S511. Since a size of the object image differs before and after its selection, the user can easily recognize an object image that is the selected object image.

At step S516, display means 207 of mobile terminal 30 displays the current live camera image overlaid on the map image, as shown in FIG. 8. Also, the current live camera image is displayed so as not to overlap the object image selected at step S512. Accordingly, the user can easily recognize a position at which the live camera image being displayed is captured by network camera 40. Also, since the current live camera image is overlaid on the map image, by selecting an object image displayed as superimposed on the map image, the user can easily view the live camera image at the desired position. Furthermore, since displayed object images correspond to categories of imaging targets of network cameras 40, the user can reference categories of imaging targets to select an object image that corresponds to a desired live camera image.

The processing at steps S513 to S516 is repeated until server 10 receives an end instruction from the user of mobile terminal 30. Specifically, the latest live camera image continues to be displayed on mobile terminal 30 until server 10 receives, from the user of mobile terminal 30, an instruction to end the display of the live camera image displayed at step S516.

If the user of mobile terminal 30 changes the map display range (designates enlargement/reduction) or the display center position by performing a scrolling operation or the like on the map, map information is acquired from server 10 based on the new position information, a map is displayed based on the acquired map information, and the object image of network camera 40 disposed at a position corresponding to the position on the map is displayed as superimposed on the map. In other words, the position where the network camera indicated by the displayed object image is disposed need not necessarily be related to the current position of mobile terminal 30.

Conventionally, considerable time and effort is required to search for a desired image among live camera images from cameras that are disposed at various places and to obtain images of various types of content. Even when a user could search for a desired image, due to the nature of live camera images in particular, viewing often lasts only for a moment, and an amount of time required for a search has taken far longer than a viewing time afforded, which has impeded motivation of a user to utilize live camera images.

According to the above-described embodiment, the user can intuitively perceive a capture location and a general content of an image, thus allowing the user to easily search for a desired image. As a result, installation and utilization of live cameras is promoted.

3. Variations

The present invention is not limited to the above-described embodiments, and various modifications are possible. Several variations will be described below. The configurations described in the following variations may be used in any combination with each other, so long as no contradiction results.

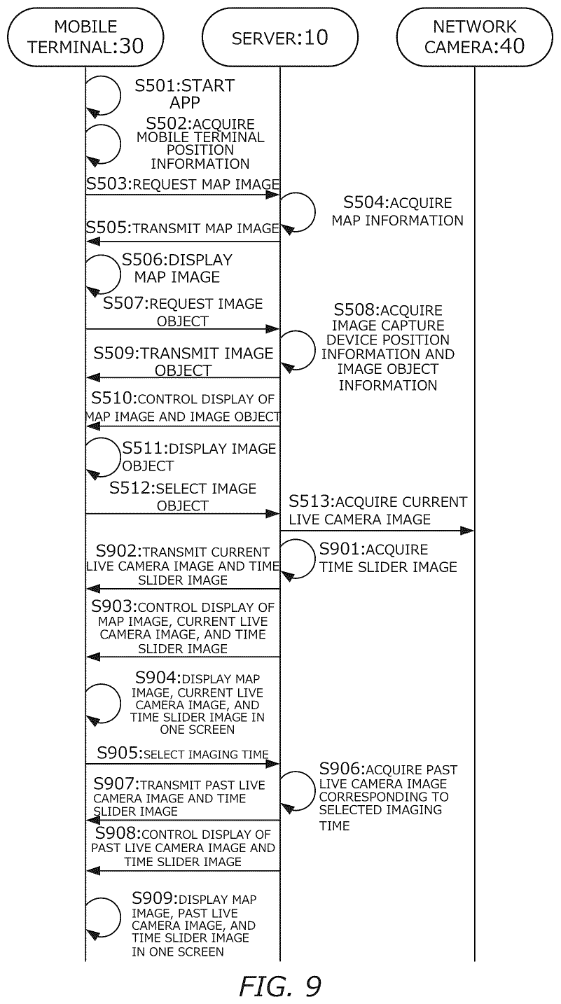

FIG. 9 is a sequence diagram illustrating processing for displaying a past live camera image and a map image on one screen. Unlike the processing shown in FIG. 5, the processing shown in FIG. 9 enables a map image and an image captured by network camera 40 in the past (hereinafter referred to as a past live camera image) to be displayed on one screen. Live camera images captured by network camera 40 over a predetermined past period are stored in storage means 205 of server 10. The predetermined period is determined in advance by the application administrator or the like.

Processing at steps S501 to S513 is the same as the processing shown in FIG. 5, and description thereof is omitted.

At step S901, acquisition means 210 of server 10 acquires a time slider image that corresponds to a current live camera image acquired at step S513. The time slider image is an image for prompting the user to select a past live camera image, and is stored in storage means 205 of server 10.

At step S902, transmission means 211 of server 10 transmits the current live camera image and the time slider image acquired at step S901 to mobile terminal 30.

At step S903, display control means 206 of server 10 performs display control such that a map image and the live camera image and time slider image transmitted at step S902 are displayed on one screen on mobile terminal 30.

At step S904, display means 207 of mobile terminal 30 displays the live camera image and the time slider image that were transmitted at step S902 on one screen.

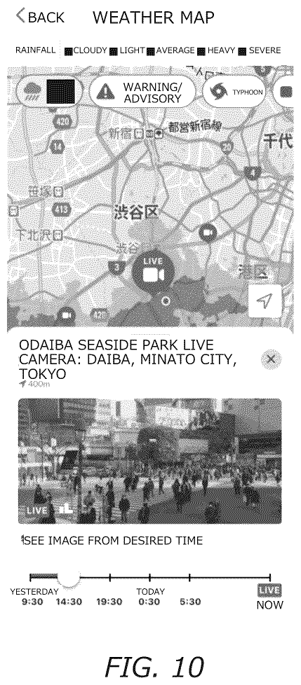

FIG. 10 is a diagram showing display of a time slider image on mobile terminal 30. The current live camera image that was transmitted at step S902 is displayed on mobile terminal 30. In addition to the current live camera image, a time slider image for receiving an instruction to display a past live camera image captured by network camera 40 that corresponds to the current live camera image is also displayed on mobile terminal 30. The times that can be selected by the user via the time slider image are determined in advance by the application administrator. In the diagram shown in FIG. 10, assuming that the time when the user is viewing the image shown in FIG. 10 is the current time, the times that can be selected via the time slider image are times from 9:30 am of the previous day to the current time.

At step S905, selection means 208 of mobile terminal 30 selects an image capture time based on an operation performed on mobile terminal 30 by the user (corresponding to timing designation). The operation performed on the mobile terminal by the user is a touch operation performed on a desired point on the time slider image, for example. Receiving means 209 of server 10 receives the image capture time selection.

At step S906, acquisition means 210 of server 10 acquires, from network camera 40, the past live camera image that corresponds to the image capture time selected by server 10 at step S905.

At step S907, transmission means 211 of server 10 transmits the past live camera image acquired at step S906 and the time slider image to mobile terminal 30. The time slider image transmitted at step S907 is different from the time slider image transmitted at step S902. If the image capture time selected at step S905 indicates 14:30 of the previous day, a button is displayed at the corresponding time, as with the time slider image included in the diagram shown in FIG. 10. Namely, the image capture time of the past live camera image that was transmitted to mobile terminal 30 at step S907 corresponds to the time that corresponds to the position of the button on the time slider image.

At step S908, display control means 206 of server 10 performs display control such that the map image, the past live camera image transmitted at step S510, and the time slider image are displayed on one screen on mobile terminal 30.

At step S909, display means 207 of mobile terminal 30 displays the map image, the past live camera image, and the time slider image on one screen.

By selecting an image capture date from among options, the user can easily view an image that was captured at a desired timing. This completes the description of the processing shown in FIG. 9.

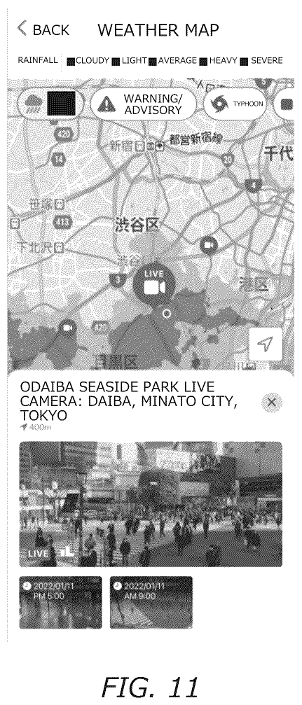

FIG. 11 is a diagram showing simultaneous display of a current live camera image and a past live camera image on mobile terminal 30. Two past live camera images and one current live camera image are displayed on mobile terminal 30. Among the three live camera images, the current live camera image is displayed in the largest size. However, the live camera image that is displayed in the largest size may be changed in accordance with an instruction from the user. For example, if the user touches a live camera image displayed in a size smaller than the other live camera images via display 3051 of mobile terminal 30, display control means 206 of server 10 controls the display such that the touched live camera image is displayed in a size larger than the other live camera images.

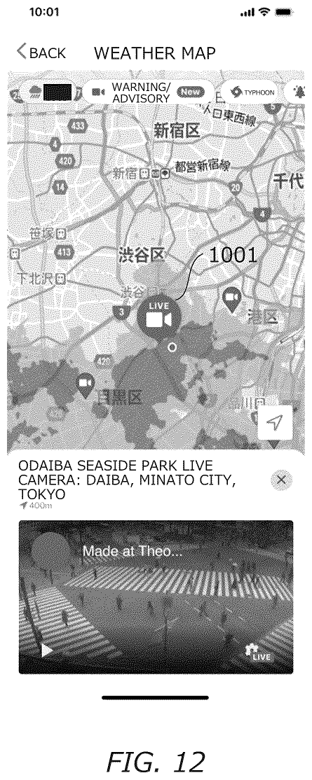

FIG. 12 is a diagram showing an example in which an image related to rain clouds and a live camera image are simultaneously displayed on one screen on mobile terminal 30. In the example shown in FIG. 8, an object image is displayed when live camera button 83 is selected, but in the example shown in FIG. 12, when rain cloud button 81 is selected, an image related to rain clouds is displayed, and object image 1001 related to a live camera is also displayed. When object image 1001 related to a live camera is selected, the live camera image that corresponds to object image 1001 is displayed together with the image related to rain clouds. Since image object 1001 is displayed together with the image related to rain clouds, the user can recognize the area where it is raining by viewing the image related to rain clouds, select the desired object image 1001, and view the live camera image to check the rainfall situation at the position in real space that corresponds to the position of object image 1001. Note that object image 1001 related to a live camera is not limited to being displayed at the time when rain cloud button 81 is selected. For example, object image 1001 related to a live camera may be displayed if live camera button 83 is selected after rain cloud button 81 has been selected. Namely, live camera button 83 may be in the selected state, and one or more display selection object images other than live camera button 83 may be in the selected state. Also, the display selection object images displayed on mobile terminal 30 are not limited to rain cloud button 81, typhoon button 82, and live camera button 83. Other examples include object images for selecting types of weather information other than rain clouds and typhoons. A configuration is possible in which it is possible to select a plurality of object images for selecting a type of weather information. Examples of information related to weather include information indicating wind speed distribution and information indicating a degree of water rise in a river. In other words, mobile terminal 30 can simultaneously display a plurality of pieces of weather information that correspond to the selected display selection object images.

Network camera 40 that corresponds to the object image selected at step S508 is not limited to being specified by server 10, and may be specified by mobile terminal 30. For example, a configuration is possible in which mobile terminal 30 specifies an object image by determining an object image at a position with coordinates including the coordinates of the position on the map image touched by the user (position coordinates on the screen) at step S512, and request server 10 to transmit a current live camera image captured by network camera 40 that corresponds to the specified object image.

The object image displayed at step S516 is not limited to being displayed in a size larger than the object image displayed at step S511, and may be displayed in a different manner from the object image displayed at step S511. For example, a configuration is possible in which the object image displayed at step S511 is displayed statically, and the object image displayed at step S516 is displayed with a blinking motion. As another example, the object image displayed at step S516 and the object image displayed at step S511 may have different colors.

The live camera image displayed on mobile terminal 30 is not limited to either a current live camera image or a past live camera image, and both a current live camera image and a past live camera image may be displayed together.

Network camera 40 is not limited to being fixed at a particular location, and may mobile by being mounted to an unmanned aerial vehicle such as a drone. In this case, the coordinates indicating a position of network camera 40 in real space may be three-dimensional coordinates instead of two-dimensional coordinates. Also, the unmanned aerial vehicle periodically transmits its own position information to server 10. Server 10 receives such information and updates corresponding image capture device position information in the network camera database.

The category of the imaging target of network camera 40 is not limited to an actual imaging target, such as a building, mountain, or river, and may be anything that indicates a characteristic of an imaging target. The category of the imaging target may be the actual imaging target, such as a sea, a forest, or the sky, or may be a characteristic of the imaging target, such as a degree of crowding at the imaging target. In other words, the category of the imaging target of network camera 40 may include a characteristic of the actual image captured by network camera 40, a purpose for capturing images, or a purpose for installing the network camera (e.g., crime prevention, monitoring of river flooding, or detection of road congestion), and a focal point or range of image capture (whether it is near the ground (near field) or in the sky (distant)). Namely, the category is tag information associated with network camera 40 or the captured image (or the image to be captured).

The live camera image displayed on mobile terminal 30 may or may not include sound. If the live camera image includes sound, the object image displayed on the map may include a UI object for switching sound output on and off.

The number of types of object images is not limited to four types, and may be any number. Also, the object images may be distinguished from each other by a feature other than the pictures included in the object images. Examples of other features include a color of the object image, a shape of the object image, a display format of the object image, and a size of the object image. Examples of display formats of an object image include a still image or a moving image, and both an object image that is a still image and an object image that is a moving image may be displayed together on a map image.

When live camera button 83 is selected at step S512, mobile terminal 30 may display a map image in which live camera button 83 is substantially centered.

The method of selecting a live camera image to be displayed on mobile terminal 30 is not limited to a method in which mobile terminal 30 selects an object image. For example, a configuration is possible in which, if a live camera image is already displayed on mobile terminal 30, the user can perform a swipe operation on a carousel that includes a plurality of live camera images in order to switch the live camera image that is displayed on mobile terminal 30.

The image capture time of a past live camera image is not limited to selection by use of the time slider image on mobile terminal 30. For example, a configuration is possible in which a thumbnail image of a still image that corresponds to a past live camera video is displayed on mobile terminal 30, and the past live camera image is displayed as a moving image if the thumbnail image is selected.

Past live camera image data is not limited to being stored in network camera 40, and may also be stored in server 10. Server 10 may store past live camera image data obtained from a plurality of network cameras 40.

The live camera image is not limited to being displayed on the lower side of the map image as shown in FIG. 8. For example, the live camera image may be displayed at any position that does not overlap the object image selected at step S512, and if the object image selected at step S512 is located on the lower side of the map image, the live camera image may be displayed on the upper side of the map image.

The live camera image displayed together with the map image is not limited to the live camera image as shown in FIG. 8, and may be a window that includes the live camera image as shown in FIG. 10, for example.

The image displayed together with the map image on mobile terminal 30 is not limited to a rain cloud image, a typhoon image, or a live camera image. The image displayed together with the map image may also be an image showing a traffic congestion status, a crowding status, a route map, or a natural disaster status, for example. In a case where an image showing a traffic congestion status, a crowding status, a route map, a natural disaster status, or the like is to be displayed on the map image, the display selection object image that corresponds to that image may be displayed on mobile terminal 30 together with the map image.

The correspondence relationships between functional elements and hardware elements in information processing system S are not limited to the relationships illustrated in the above embodiment. For example, some of the functions described as functions of server 10 in the above embodiment may be implemented in another server. Alternatively, some of the functions described as functions of server 10 in the above embodiment may be implemented in another device on the network. Also, server 10 may be a physical server or a virtual server (including the so-called cloud).

The operations performed in information processing system S are not limited to the examples described above. The order of the processing steps performed in information processing system S may be changed as long as no contradiction arises. Also, a part of the processing procedure performed in information processing system S may be omitted. For example, in FIGS. 5 and 9, map image request, acquisition, and transmission, as well as object image request, acquisition, and transmission are executed at different timings, but they may be executed at the same time. Also, object image request, acquisition, and transmission are not necessarily required, and as another example, a configuration is possible in which when a map image is requested, a map image with an object image overlaid thereon is acquired, and the map image with the object image overlaid thereon is transmitted.

Various programs illustrated as examples in the embodiments may be provided by being downloaded via a network such as the Internet, or may be provided in recorded form on a computer-readable non-transient recording medium such as a DVD-ROM (Digital Versatile Disc Read Only Memory).

### REFERENCE SIGNS LIST

10 Server
20 Network
30 Mobile terminal
40 Network camera
101 CPU
102 Memory
103 Storage
104 Communication IF
201 Detection means
202 Acquisition means
203 Request means
204 Acquisition means
205 Storage means
206 Display control means
207 Display means
208 Selection means
209 Receiving means
210 Acquisition means
211 Transmission means
301 Processor
302 Memory
303 Interface
304 Communication unit
305 Output unit
306 Input unit
307 Positioning system
3051 Display
3061 Touch panel

What is claimed is:

1. A computer implementation method for causing a computer to execute:
displaying a map on which, from among object images of a plurality of types, an object image of a type having an attribute of an image target of an image capture device disposed at a predetermined position is overlaid at a position corresponding to the predetermined position; and
receiving selection of the displayed object image,
wherein in the displaying step, both the map and an image captured by the image capture device corresponding to the selected object image are displayed on one screen.

2. The computer implementation method according to claim 1,
wherein in the displaying step, a real-time image captured by the image capture device is displayed.

3. The computer implementation method according to claim 1, further comprising the step of:
determining from among a plurality of images captured by the image capture device an image to be displayed on a display unit, based on a timing,
wherein in the displaying step, the map and the image determined to be displayed in the determining step are displayed on one screen.

4. The computer implementation method according to claim 3, further comprising the step of:
receiving designation of the timing,
wherein in the determining step, an image corresponding to the designated timing is determined to be displayed on the display unit.

5. The computer implementation method according to claim 3,
wherein in the displaying step, the map, the image determined to be displayed in the determining step, and an image being captured by the image capture device are displayed on one screen.

6. An information processing terminal comprising:
a memory; and
a processor,
the processor configured to:
display a map on which, from among object images of a plurality of types, an object image of a type having an attribute of an image target of an image capture device disposed at a predetermined position is overlaid at a position corresponding to the predetermined position; and
receive selection of the object image displayed by the display means,
wherein the processor displays both the map and an image captured by the image capture device corresponding to the selected object image on one screen.

7. An information processing device comprising:
a processor;
a display;
a communication unit configured to communicate with a mobile terminal;
a memory that stores a correspondence relationship between an image capture device, position information of the image capture device, and attribute information regarding an imaging target of the image capture device, and a correspondence relationship between the attribute information and an object image,
the processor is configured to:
control the display to display a map and, from among object images of a plurality of types, an object image of a type having the attribute information at a position corresponding to the position information; and
receive selection of the object image displayed under control of the display control means,
wherein the processor controls the display to display, on one screen, the map and an image captured by an image capture device corresponding to the object image corresponding to the selection received by the receiving means.
